(19) United States
(12) Patent Application Publication
(10) Pub. No.: US 2007/0216109 A1
(43) Pub. Date: Sep. 20, 2007

(54) Turbocharger gasket

(75) Inventor: Thomas Friedow, Plymouth, MI (US)

Correspondence Address: Edward J. Timmer, P.O. Box 770, Richland, MI, 49083-0770, US

(73) Assignee: ElringKlinger AG

(21) Appl. No.: 11/377,922

(22) Filed: Mar. 16, 2006

(51) Int. Cl. F02F 11/00

(52) U.S. Cl. 277/593

(57) ABSTRACT

Gasket for an engine exhaust gas-driven turbochager includes a gasket plate having at least one metallic gasket layer, an exhaust gas opening, at least one sealing bead deformable in height surrounding the exhaust gas opening, and at least one deformation limiting element adjacent the sealing bead and having a height profile so formed prior to installation of the gasket as to vary around the exhaust gas opening in manner to maintain a sufficient gasket sealing function at the very high temperatures of 800 degrees C. and above experienced by the gasket during operation of the turbocharger. The sealing bead and the deformation limiting element can be formed on the same metallic gasket layer for a single layer gasket or on different metallic gasket layers for a multi-layer gasket.

### FIELD OF THE INVENTION

The present invention relates to a gasket for an exhaust gas-driven turbocharger and, more particularly to a gasket for sealing an exhaust gas inlet or outlet of the turbocharger wherein the gasket is subjected to elevated operating temperatures of 800 degrees C. and above.

### BACKGROUND OF THE INVENTION

Cylinder head gaskets comprising one or multiple sheet metal layers are known which include a combustion chamber opening, a substantially elastically deformable sealing bead disposed around the combustion chamber opening, and one or more deformation limiting means (also called stopper) disposed proximate the sealing bead in the same or different gasket layer to limit deformation of the sealing bead during operation of the engine. The stopper typically is provided as a ring-shaped thickened region of the gasket by various techniques. Moreover, the thickness of the stopper can be varied about the combustion chamber opening in order to compensate for the locally differing mechanical stiffness and the locally differing thermal expansion of the cylinder head and/or engine block.

The stopper can be formed by various techniques. For example, a stopper can be provided on the gasket by welding a preformed metallic stopper ring on a sheet metal support layer of the gasket in a manner that the stopper ring surrounds the combustion chamber opening, U.S. Pat. No. 6,053,503. Alternately, the stopper can be formed by folding over the edge of a metallic gasket layer at and around the combustion chamber opening, U.S. Pat. No. 6,926,282. Still further, the stopper can be formed as a pattern of discrete stopper elevations/depressions around the combustion chamber opening by deforming a gasket layer using a multi-part deep drawing tool, U.S. Pat. Nos. 6,152,456; 6,769,696; and 6,814,357.

Exhaust manifold gaskets also are known comprising one or multiple sheet metal layers having an exhaust gas opening, an elastically deformable sealing bead disposed around the exhaust gas opening, and a deformation limiting means (stopper) disposed proximate the sealing bead in the same or different gasket layer to limit deformation of the sealing bead during operation of the engine.

To improve performance of an internal combustion engine, it is known to provide an exhaust gas-driven turbocharger mounted between the engine exhaust manifold and an exhaust “down” pipe. The turbocharger includes an turbine wheel driven to rotate by hot exhaust gas conducted from the exhaust manifold through an exhaust gas inlet of the turbocharger to an exhaust gas outlet of the turbocharger. The turbocharger also includes a compressor wheel driven by the turbine wheel to draw in and compress outside air above atmospheric pressure for discharge to the engine as is well known.

The exhaust gas inlet and outlet of the turbocharger have been sealed at cooperating flanges of the turbocharger and the exhaust manifold and at similar cooperating flanges of the turbocharger and the exhaust “down” pipe. Sealing at the cooperating flanges using gaskets presents formidable problems as a result of the very high temperatures experienced by the gaskets at the exhaust gas inlet and exhaust gas outlet of the turbcharger. For example, flange temperatures and thus gasket temperatures of 800 degrees C. and above up to 960 degrees C. have been measured during turbocharger operation.

One gasketing scheme that has been employed to seal the exhaust gas inlet and outlet of the turbocharger has involved providing a machined groove in one of the cooperating flanges and placing an annular metal gasket ring having a hollow, polygonal cross-section in the groove. However, this gasketing scheme is disadvantageous as a result of the high cost of machining the groove and of the hollow metal gasket ring.

Another gasketing scheme that has been employed to seal the exhaust gas inlet and outlet of the turbocharger has involved placing a metal gasket plate having one or two sheet metal (e.g. Type 309 stainless steel) gasket layers between the cooperating flanges wherein one or both of the sheet metal gasket layers includes a sealing bead for sealing around the exhaust gas opening. However, these metal gasket plates are disadvantageous in that they have been unable to maintain an effective sealing function as a result of occurrence of large dynamic changes in the sealing gap between the cooperating flanges at the very high service temperatures (e.g. 800 degrees C. and above) during operation of the turbocharger. For example, when using such gaskets, dynamic changes of the sealing gap of 150 to 160 micrometers have been measured in certain applications where gasket temperatures have been in the range of 850 to 960 degrees C., resulting in a loss of the sealing function at these service temperatures.

An object of the present invention is to provide a turbocharger gasket for overcoming these disadvantages.

### SUMMARY OF THE INVENTION

The present invention provides a gasket for an exhaust gas-driven turbochager wherein the gasket experiences operating temperatures of 800 degrees C. and above and wherein the gasket is capable of maintaining effective function at such service high temperatures. A turbocharger gasket pursuant to the invention comprises a gasket plate having at least one metallic gasket layer, an exhaust gas opening, at least one sealing bead deformable in height surrounding the exhaust gas opening, and at least one deformation limiter for delimiting deformation of the sealing bead. The at least one deformation limiter can comprise at least one deformation limiting element having a height profile (thickness) so formed prior to installation of the gasket as to vary around the exhaust gas opening in manner to maintain gasket sealing function at such high gasket operating temperatures. The sealing bead and the deformation limiting element can be formed on the same metallic gasket layer for a single layer gasket or on different metallic gasket layers for a multi-layer gasket.

In an illustrative embodiment of the invention, the deformation limiting element includes a height profile having relatively greater height sections located intermediate certain gasket fastener holes and having lesser height sections proximate the gasket fastener holes. Each greater height section can be connected to neighboring lesser height sections by respective ramp transition sections.

In a preferred embodiment of the invention, the turbocharger gasket comprises first and second outer metallic gasket layers and an inner metallic gasket layer between the outer metallic gasket layers. Each of the outer metallic gasket layers includes an exhaust gas opening and a sealing bead deformable in height surrounding the exhaust gas opening thereof. The inner metallic gasket layer includes an exhaust gas opening and deformation limiter for delimiting deformation of the sealing bead wherein the deformation limiter comprises at least one deformation limiting element of the type described above.

The outer metallic gasket layers preferably each comprises a relatively harder stainless steel gasket layer and the inner metallic gasket layer preferably comprises a relatively softer stainless steel gasket layer. The relatively harder outer stainless steel gasket layers can have a greater thickness than the relatively softer stainless steel inner gasket layer. The outer metallic gasket layers each can include a high temperature coating (e.g. boron nitride coating) thereon.

The present invention further envisions the combination of an engine exhaust manifold, a turbocharger having an exhaust gas inlet communicated to the exhaust manifold, and a gasket of the type described above between the engine exhaust manifold and the turbocharger.

The present invention still further envisions the combination of an engine exhaust pipe, a turbocharger having an exhaust gas outlet communicated to the exhaust pipe, and a gasket of the type described above between the turbocharger and the exhaust pipe.

The turbocharger gasket pursuant to the present invention is advantageous to maintain effective sealing at the very high gasket operating temperatures of 800 degrees C. and above experienced during operation of the turbocharger. Moreover, use of a turbcharger gasket pursuant to the invention avoids the need to machine a groove in flanges of the exhaust manifold or the exhaust “down” pipe.

These and other advantages of the invention will become more readily apparent from the following detailed description taken with the following drawings.

### DESCRIPTION OF THE DRAWINGS

FIG. 1 is a perspective view of an exhaust gas-driven turbocharger having an exhaust gas inlet opening at a first flange that is adapted to be joined to a flange of an engine exhaust manifold of an internal combustion engine and an exhaust gas outlet opening at a second flange that is adapted to be joined to a flange of an engine exhaust “down” pipe. An exhaust gas outlet gasket pursuant to an embodiment of the invention is shown; the exhaust gas inlet gasket pursuant to another embodiment of the invention is omitted from FIG. 1 for convenience and is shown in FIGS. 2-5.

FIG. 2 is an elevational view of a turbocharger exhaust gas inlet gasket pursuant to an embodiment of the invention for sealing the joint between the first exhaust gas inlet flange of the turbocharger and the flange of the exhaust manifold.

FIG. 3 is a partial sectional view of the gasket of FIG. 2 taken along lines 3-3.

FIG. 4 is a partial sectional view of the gasket of FIG. 2 taken along lines 4-4.

FIG. 5 is a plan view of the inner gasket layer showing the height profile of the stopper element.

FIG. 6 is an elevational view of a turbocharger exhaust gas outlet gasket pursuant to still another embodiment of the invention for sealing the joint between the second exhaust gas outlet flange of the turbocharger and the flange of the exhaust pipe.

FIG. 7 is a partial sectional view of the gasket of FIG. 6 taken along lines 7-7.

FIG. 8 is a plan view of the inner gasket layer showing the height profile of the stopper element.

### DETAILED DESCRIPTION OF THE INVENTION

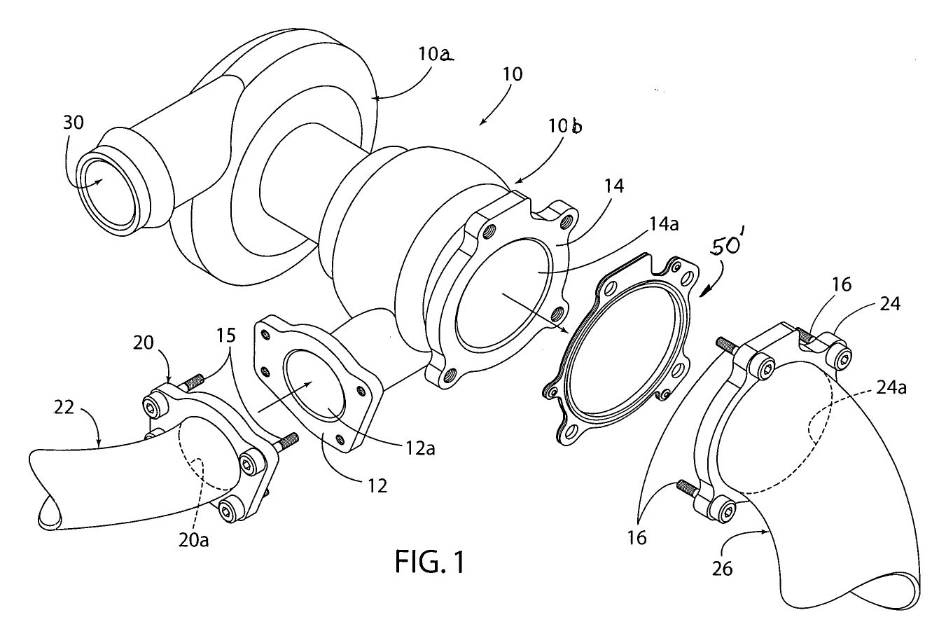

Referring to FIG. 1, an illustrative conventional exhaust gas-driven turbocharger 10 is shown to include a first flange 12 having an exhaust gas inlet opening 12a and a second flange 14 having an exhaust gas outlet opening 14a. The first flange 12 is adapted to be clamped by conventional fasteners 15, such as threaded bolts or screws, to a flange 20 of an exhaust manifold 22 (partially shown) of an internal combustion engine. The second flange 14 similarly is adapted to be clamped by conventional fasteners 16, such as threaded bolts or screws, to a flange 24 of an engine exhaust “down” pipe 26 (partially shown).

The turbocharger 10 also includes an air inlet (not shown) through which ambient air is drawn by a compressor wheel (not shown) disposed inside the turbocharger housing region 10a. As is well known, the compressor wheel is connected via a shaft (not shown) to a turbine wheel (not shown) inside the turbocharger housing region 10b such that the hot engine exhaust gas discharged from the exhaust gas opening 20a of the exhaust manifold flange 20 enters the exhaust gas inlet opening 12a of the turbocharger to flow past the turbine wheel to impart rotation thereto. The turbine wheel drives the compressor wheel to rotate and draw intake air into the air inlet opening for compression above atmospheric pressure and discharge via compressor discharge air opening 30 to the engine intake manifold. After flowing past the turbine wheel, the exhaust gas exits the turbocharger via exhaust gas outlet opening 14a for flow through the exhaust pipe flange opening 24a to the exhaust pipe 26 (partially shown).

During operation of the turbocharger 10, the first flange 12 and the second flange 14 reach very high temperatures measured to be 800 degrees C. and above up to as high as 960 degrees C. in one particular turbocharger application. The second flange 14 may be slightly Lower in temperature than the first flange 12.

The present invention provides turbocharger gaskets for sealing around the exhaust gas openings 12a, 20a between the first turbocharger flange 12 and the exhaust manifold flange 20 and for sealing around the exhaust gas openings 14a, 24a between the second turbocharger flange 14 and the exhaust pipe flange 24. Turbocharger gaskets pursuant to the invention are capable of maintaining effective sealing function at such high gasket service temperatures.

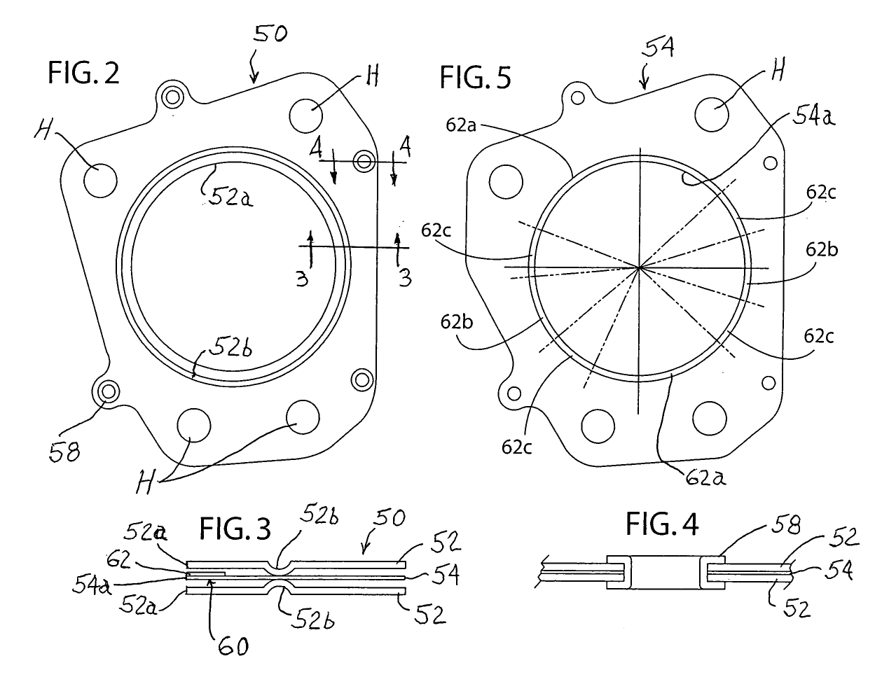

Referring to FIGS. 2 and 3, an illustrative turbocharger gasket 50 is shown for sealing the exhaust gas openings 12a, 20a between the first turbocharger flange 12 and the exhaust manifold flange 20. The gasket 50 is shown as a gasket plate having multiple gasket layers 52, 54 for purposes of illustration and not limitation. The gasket layers 52, 54 are illustrated as being fastened together by a plurality of hollow rivets 58 as shown in FIGS. 2 and 4, although any suitable means can be used to fasten the gasket layers together to form the gasket plate. The invention is not limited to multilayer gaskets and can comprise a single metallic gasket layer as well.

The gasket plate 50 comprises first and second outer metallic gasket layers 52 and inner metallic gasket layer 54 between the outer gasket layers 52. The first and second outer gasket layers 52 are adapted to sealingly cooperate with respective adjacent sealing surfaces of the turbcharger flange 12 and exhaust manifold flange 20. The outer gasket layers 52, 54 include through-holes H to receive the clamping fasteners 15 by which the turbocharger flange 12 is fastened to the exhaust manifold flange 20. The fasteners 15 are tightened in a manner to preload the gasket 50 in compression between the flanges 12, 20.

Each of the outer gasket layers 52 includes an exhaust gas opening 52a associated with the exhaust gas openings 12a, 22a, a sealing bead 52b that is elastically and plastically deformable in height surrounding the exhaust gas openings, and fastener-receiving holes H to receive the fasteners 15.

The exhaust gas openings 52a are shown as circular openings that are substantially congruent with the exhaust gas openings 12a, 20a when the turbocharger flange is fastened to the exhaust manifold flange. In practice of the invention, the exhaust gas openings 52a of outer gasket layers 52 as well as exhaust gas opening 54a of the inner gasket layer 54 can have any suitable shape to suit a particular configuration of the exhaust manifold.

The sealing beads 52b are illustrated as a full beads surrounding the exhaust gas inlet openings 52a of the gasket layers 52 to provide gas-tight sealing around the exhaust gas openings 12a, 22a. Although the sealing beads 52b are illustrated as having a full bead configuration, sealing beads elastically deformable in height can have any suitable configuration in practice of the invention to provide a sufficiently gas-tight seal around the exhaust gas openings 12a, 20a. For purposes of further illustration and not limitation, the sealing beads 52b can have a step-like half-bead configuration.

As a result of the very high gasket operating temperatures encountered, the first and second outer gasket layers 52 are formed of a stainless steel having relatively high elevated temperature hardness and strength. For purposes of illustration and not limitation, the outer gasket layers 52 can be formed of Type 309 (European Material 1.4828 designation) austenitic stainless steel to this end. Each of the major sides of the outer metallic gasket layers 52 preferably can be provided with an optional layer or coating of boron nitride (BN) of suitable thickness to compensate for roughness of the sealing surfaces of flanges 12, 20. For purposes of illustration and not limitation, the BN coating can have a thickness of 20 micrometers on each major side of the gasket layers 52 to this end.

The inner gasket layer 54 includes an exhaust gas opening 54a shown as a circular opening that is substantially congruent with the exhaust gas openings 12a, 20a when the turbocharger flange 12 is fastened to the exhaust manifold flange 20.

The gasket 50 includes at least one deformation limiter 60 to prevent total compression of the sealing beads 52b as a result of dynamic sealing gap variations occurring during operation of the turbocharger. The deformation limiter 60 is illustrated as being provided on the inner gasket layer 54 such that the inner gasket layer 54 functions as a deformation limiting sheet in this embodiment of the invention. Those skilled in the art will appreciate that the deformation limiter 60 can be provided on any one or more of the gasket layers 52, 54.

Referring to FIG. 3, the deformation limiter 60 is shown comprising a folded-over flange stopper element 62 that extends around the circumference of the exhaust gas opening 54a in a ring shape, although the invention is not limited to a continuous ring-shaped stopper element. The stopper element 62 can have any shape in plan view suited to a particular exhaust gas opening and may be interrupted by spaces or gaps such that the stopper element is not continuous about the exhaust gas opening. For example, the stopper element can include multiple folded-over stopper element sectors about the periphery of the exhaust gas opening where the folded-over stopper element sectors are separated from adjacent folded-over stopper element sectors by a gap or space that comprises a non-folded-over region of the gasket sheet. Interruption of the stopper element 62 in this manner can be used in connection with a non-circular (e.g. triangular shaped) exhaust gas opening having one or more sharp radial corners, the non-folded-over region(s) of the gasket sheet forming the gap(s) or space(s) being located proximate the radial corners.

The flange stopper element 62 is formed by the edge region of the inner gasket layer 54 being bent out of its plane and folded over radially outwardly onto the upper side of the inner gasket layer 54 as shown in FIG. 3. The stopper element 62 thus comprises a thickened region of the inner gasket layer 54 at the edge of the exhaust opening 54a, although the stopper element can be provided at other locations on the inner gasket layer 54 in this embodiment.

When the gasket 50 comprises a single gasket layer, the stopper element and the sealing bead of course are provided on the same gasket layer about the exhaust gas opening thereof.

The stopper element 62 is formed prior to installation of the gasket 50 between the flanges 12, 20 with a height profile that varies around the exhaust gas inlet opening 54a of the inner gasket layer 54 to compensate for variations in the mechanical stiffness and the thermal expansion of the flanges 12, 20 and reduce or limit dynamic changes in the sealing gap to an extent that the gasket 50 can provide effective sealing at the high gasket operating temperatures experienced during turbocharger operation. That is, the thickness dimension of the stopper element 62 in a direction perpendicular to the plane of the gasket layer 54 is varied about the exhaust gas opening 54a.

For purposes of illustration and not limitation, the height profile of the stopper element 62 preferably is selected to reduce or limit dynamic changes in the sealing gap to about 10 micrometers or less. The height profile preferably is formed prior to installation of the gasket to substantially comply with the topography of surfaces of flanges 12, 14 defining the sealing gap and between which the gasket is to be clamped, the topography corresponding to the topography of the flange surfaces during operation of the engine.

Referring to FIG. 5, the height profile of the stopper element 62 varies about the exhaust gas opening to provide a lesser height stopper section 62a proximate each respective fastener-receiving hole H and a greater height stopper section 62b intermediate certain adjacent fastener-receiving holes H. Each greater height section 62b is connected to a neighboring lesser height section 62a by respective transition ramp sections 62c. In FIG. 5, the arc lengths (circumferential lengths) of the stopper sections 62a, 62b, and 62c are shown extending between the radial dashed reference lines for purposes of better illustrating the arcuate extents of the different stopper sections.

For purposes of illustration and not limitation, an exemplary turbocharger gasket 50 of the type shown in FIGS. 2, 3 and 5 comprises Type 309 (European Material 1.4828 designation) austentic stainless steel outer gasket layers 52 with a thickness of about 0.30 mm and a Type 304 (European Material 1.4301 designation) austentic stainless steel inner gasket layer 54 with a thickness of about 0.15 mm. Gasket layers 52 and 54 have respective exhaust gas openings having a diameter about of 62 mm.

The inner gasket layer 54 is provided with the folded-over stopper element 62 which includes lesser height sections 62a and greater height sections 62b. For purposes of illustration and not limitation, the greater height sections 62b have a height (thickness) that corresponds to the original full height of the folded-over stopper element 62. For example, in the above exemplary embodiment the greater or full height sections 62b have a height of about 0.30 mm as a result of the folding over of gasket layer 54 onto itself.

Referring to FIG. 5, the greater height sections 62b are disposed generally intermediate certain adjacent fastener-receiving holes H where relatively large dynamic changes in the sealing gap occur during operation of the turbocharger. The greater height sections 62b are illustrated as having similar arc lengths (circumferential lengths), such as about 35 degrees about the exhaust gas opening 54a of the gasket layer 54. However, those skilled in the art will appreciate that the greater height sections 62b can have the same or different arc lengths and heights depending on the configuration of the gasket, flange stiffness, fastener hole locations, and operating conditions.

The lesser height sections 62a have a reduced height as compared to the greater height sections 62b. In particular, for the exemplary gasket being described, the height of the sections 62a is about 30 micrometers less than the height of the greater height sections 62b. The lesser height sections 62a are disposed proximate the fastener-receiving holes H where dynamic changes of the sealing gap are less during operation of the turbocharger. The lesser height sections 62a are illustrated as having different arc lengths (circumferential lengths) in FIG. 5. For example, the arc length of the uppermost section 62a in FIG. 5 is about 117 degrees. The arc length of the lowermost section 62a in FIG. 5 is about 73 degrees. However, those skilled in the art will appreciate that reduced height sections 62a can have the same or different arc lengths depending the configuration of the gasket, flange stiffness, fastener hole locations, and operating conditions.

In FIG. 5, the upwardly facing surfaces of the lesser height section 62a and of the greater height sections 62b are generally flat and parallel to one another and to the major sides of the gasket 50.

The transition ramp sections 62c are disposed between adjacent sections 62a and 62b and linearly ramp down from the full height of the sections 62b to the reduced height of the sections 62a. The upwardly facing surfaces of the transition ramp sections 62c are flat and extend at an acute angle relative to the major flat sides of the gasket 50. The transition ramp sections 62c are illustrated as having the same arc lengths about the exhaust gas opening 54a. For example, in FIG. 5, the arc lengths of each of the transition sections 62c is about 25 degrees. However, those skilled in the art will appreciate that the transition sections 62c can have the same or different arc lengths depending the configuration of the gasket, flange stiffness, fastener hole locations, and operating conditions.

The stopper element height profile described above has been effective to reduce dynamic changes of the sealing gap to about 10 micrometers at measured flange temperatures between 850 degrees C. to about 960 degrees C. in one particular turbocharger application, allowing the gasket to maintain its sealing function at those temperatures.

For any given turbocharger gasket application, the particular heights and widths, circumferential lengths, and locations of the stopper sections 62a, 62b, and 62c can be determined empirically and/or by using finite element analysis to provide the advantages of the invention described above.

The stopper sections 62a, 62b, and 62c can be formed on the inner gasket layer 54 by first forming the stopper element 62 around the exhaust gas opening 54a and then forming the lesser height sections 62a and the transition ramp sections 62c by conventional height profile tooling (U.S. Pat. No. 6,769,696) that presses the stopper element 62 to locally reduce its thickness at sections 62a and form a ramp configuration at sections 62c.

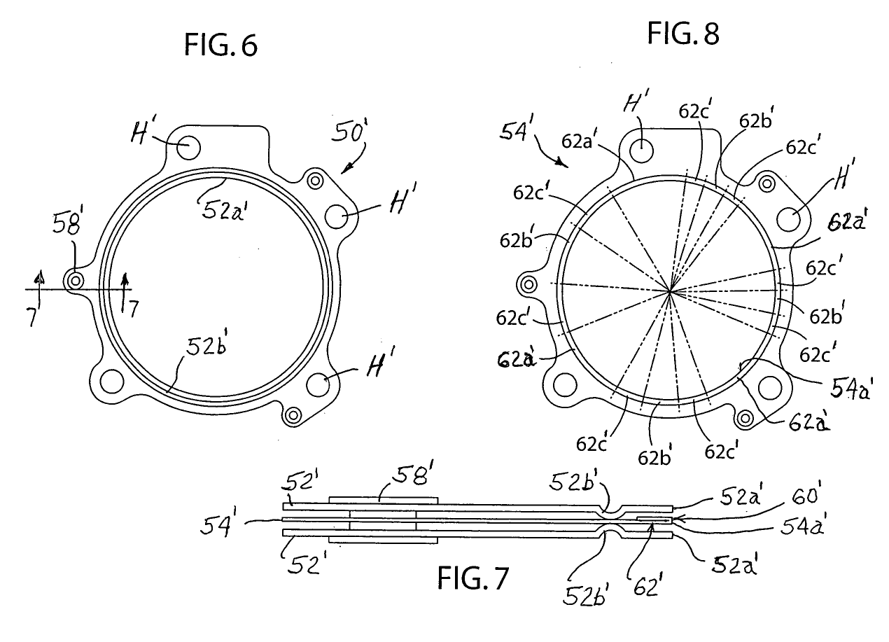

Referring to FIGS. 6-8 an illustrative turbocharger exhaust gasket 50′ is shown for sealing the exhaust gas openings 14a, 24a between the second turbocharger flange 14 and the flange 24 of the exhaust “down” pipe 26. The turbocharger gasket 50′ embodies like features as the turbocharger exhaust 50 shown in FIGS. 2-5. As a result, in FIGS. 6-8, like reference numerals primed are used for like gasket features of FIGS. 2-5.

In particular, the gasket 50′ includes first and second outer metallic gasket layers 52′ and an inner metallic gasket layer 54′ between the outer metallic gasket layers. The first and second outer gasket layers 52′ are adapted to sealingly cooperate with the respective adjacent sealing surfaces of the turbocharger flange 14 and “down” exhaust pipe flange 24.

To prevent total compression of the deformable sealing beads 52b′ of the outer gasket layers 52′ as a result of sealing gap variations occurring during operation of the turbocharger, the gasket 50′ includes deformation limiter 60′ illustrated as being provided on the inner gasket layer 54′ such that the inner gasket layer 54′ functions as a deformation limiting sheet.

Referring to FIGS. 7 and 8, the folded-over flange stopper element 62′ is formed on gasket layer 54′ prior to installation of the gasket 50′ between the flanges 14, 24 to have a height profile that varies around the exhaust gas opening 54a′ to compensate for variations in the mechanical stiffness and the thermal expansion of the flanges 14, 24 at the high gasket operating temperatures experienced during turbocharger operation. That is, the thickness dimension of the stopper element 62′ in a direction perpendicular to the plane of the gasket layer 54′ is varied about the exhaust gas opening 54a′.

Referring to FIG. 8, the height profile of the stopper element varies about the exhaust gas opening 54a′ to provide a lesser height stopper section 62a′ proximate each respective fastener-receiving hole H and a greater (full) height stopper section 62b′ intermediate certain adjacent clamping fastener holes H. Each greater height section 62b′ is connected to neighboring lesser height sections 62a′ by transition ramp sections 62c′. In FIG. 8, the arc lengths (circumferential lengths) of the stopper sections 62a′, 62b′, and 62c′ are shown extending between the radial dashed reference lines for purposes of better illustrating the arcuate extents of the different stopper sections.

For purposes of illustration and not limitation, an exemplary turbocharger gasket 50′ of the type shown in FIGS. 6-8 comprises Type 309 (European Material 1.4828 designation) austentic stainless steel outer gasket layers 52′ with a thickness of about 0.30 mm and a Type 304 (European Material 1.4301 designation) austentic stainless steel inner gasket layer 54′ with a thickness of about 0.15 mm. Gasket layers 52′ and 54′ have respective exhaust gas openings having a diameter about of 94 mm.

The inner gasket layer 54′ is provided with folded-over flange stopper element 62′ which includes lesser height sections 62a′ and greater height sections 62b′. For purposes of illustration and not limitation, the greater height sections 62b′ have a height (thickness) of about 0.30 mm as a result of the folding over of gasket layer 54′ onto itself.

In FIG. 8, the greater height sections 62b′ are disposed generally intermediate adjacent fastener-receiving holes H′. The greater height sections 62b′ are illustrated as having different arc lengths (circumferential lengths) about the exhaust gas opening 54a′ depending upon the distance between the neighboring fastener holes H′. For example, the arc length of each of the greater height sections 62b′ intermediate the more closely spaced fastener holes H′ located on the right hand side of the gasket in FIG. 8 is about 12 degrees. The arc length of the greater height section 62b′ intermediate the more widely spaced fastener holes H′ located on the left hand side of the gasket is about 30 degrees. The arc length of the greater height section 62b′ intermediate the more widely spaced fastener holes H′ located on the bottom side of the gasket in FIG. 8 is about 26 degrees. However, those skilled in the art will appreciate that the sections 62b′ can have the same or different arc lengths depending the configuration of the gasket and fastener-receiving hole locations.

The lesser height sections 62a′ have a reduced height as compared to the greater height sections 62b′. In particular, for the exemplary gasket 50′ being described, the height of the sections 62a′ is about 30 micrometers less than the height of the greater height sections 62b′. The lesser height sections 62a′ are disposed proximate the fastener holes H′ and have the same arc length of about 40 degrees about the exhaust gas opening 54a′. However, those skilled in the art will appreciate that the sections 62a′ can have the same or different arc lengths depending the configuration of the gasket and fastener holes locations.

The transition ramp sections 62c′ are disposed between adjacent sections 62a′ and 62b′ and linearly ramp down from the full height of the sections 62b′ to the reduced height of the sections 62a′. The transition ramp sections 62c′ are illustrated as having different arc lengths about the exhaust gas opening 54a′ depending upon the distance between the neighboring fastener holes H′. For example, in FIG. 8, the arc lengths of each of the transition sections 62c′ intermediate the more closely spaced fastener holes H′ located on the right hand side of the gasket in FIG. 8 are about 10 degrees. The arc lengths of each of the transition sections 62c′ intermediate the more widely spaced fastener holes H′ located on the left hand side of the gasket are about 25 degrees. The arc lengths of each of the transition sections 62c′ intermediate the more widely spaced fastener holes H′ located on the bottom side of the gasket in FIG. 8 are about 15 degrees. However, those skilled in the art will appreciate that the transition sections 62c′ can have any selection of arc lengths depending the configuration of the gasket and fastener holes locations.

The invention is not limited to the particular shape, location, and height profile of the stopper elements 62 (62′) described above. For example, the stopper elements 62 (62′) can have any suitable shape, location, width, and height profile effective to sufficiently delimit deformation of the sealing bead(s) of the gasket to protect its sealing function in service. For example, stopper elements having other configurations are described in U.S. Pat. Nos. 6,152,456; 6,769,696; 6,814,357, and others.

While the invention has been described in terms of specific embodiments thereof, it is not intended to be limited thereto but rather only to the extent set forth in the following claims.

1. Turocharger gasket for an engine exhaust gas-driven turbochager wherein the gasket experiences temperatures of 800 degrees C. and above, comprising a gasket plate having at least one metallic gasket layer, an exhaust gas opening, at least one sealing bead deformable in height surrounding the exhaust gas opening, and at least one deformation limiter for delimiting deformation of the sealing bead, said deformation limiter comprising at least one deformation limiting element adjacent the sealing bead and having a height profile formed prior to installation of the gasket to vary around the exhaust gas opening in manner to maintain sealing function at the temperatures of 800 degrees C. and above.

2. The gasket of claim 1 wherein the deformation limiting element comprises a thickened region of a metallic gasket layer.

3. The gasket of claim 2 wherein the thickened region comprises a folded-over region of the metallic gasket layer.

4. The gasket of claim 1 wherein the height profile of the deformation limiter includes relatively greater height sections located intermediate adjacent gasket fastener holes and having lesser height sections proximate the gasket fastener holes.

5. The gasket of claim 4 wherein each greater height section is connected to neighboring lesser height sections by respective ramp transition sections.

6. The gasket of claim 1 wherein the sealing bead is disposed on one metallic gasket layer and the deformation limiting element is formed on another metallic gasket layer.

7. The gasket of claim 6 wherein the sealing bead is disposed on a relatively harder stainless steel gasket layer and the deformation limiting element is formed on a relatively softer stainless steel gasket layer.

8. The gasket of claim 1 having an exhaust gas inlet opening.

9. The gasket of claim 1 having an exhaust gas outlet opening to an exhaust pipe.

10. Turbocharger gasket for an engine exhaust gas-driven turbochager on an internal combustion engine wherein the gasket experiences temperatures of 800 degrees C. and above, comprising first and second outer metallic layers and an inner metallic layer between the outer metallic layers, wherein each of the outer metallic layers includes an exhaust gas opening and a sealing bead deformable in height surrounding the exhaust gas opening thereof and wherein the inner metallic layer includes an exhaust gas opening and at least one deformation limiter for delimiting deformation of the sealing bead of each outer gasket layer, said deformation limiter comprising at least one deformation limiting element adjacent the sealing bead and having a height profile so formed prior to installation of the gasket as to vary around the exhaust gas opening in manner to maintain sealing function at the temperatures of 800 degrees C. and above.

11. The gasket of claim 10 wherein the deformation limiting element comprises a thickened region of a metallic gasket layer.

12. The gasket of claim 11 wherein the thickened region comprises a folded-over region of the metallic gasket layer.

13. The gasket of claim 10 wherein the height profile of the deformation limiting element includes relatively greater height sections located intermediate adjacent gasket fastener holes and having lesser height sections proximate the gasket fastener holes, each greater height section being connected to neighboring lesser height sections by respective ramp transition sections.

14. The gasket of claim 13 wherein the height profile is formed prior to installation of the gasket to substantially comply with the topography of flange surfaces between which the gasket is to be clamped, said topography corresponding to topography of the flange surfaces during operation of the engine.

15. The gasket of claim 10 wherein the outer metallic layers each comprises a relatively harder stainless steel gasket layer and the inner metallic gasket layer comprises a relatively softer stainless steel gasket layer.

16. The gasket of claim 15 wherein the relatively harder stainless steel comprises Type 309 austentic stainless steel and the relatively softer stainless steel comprises Type 304 austentic stainless steel.

17. The gasket of claim 10 wherein the outer metallic layers each includes a boron nitride layer thereon.

18. The gasket of claim 10 having an exhaust gas inlet opening.

19. The gasket of claim 10 having an exhaust gas outlet opening to an exhaust pipe.

20. Combination of an engine exhaust manifold, a turbocharger having an exhaust gas inlet communicated to the exhaust manifold, and the gasket of claim 8 between the engine exhaust manifold and the turbocharger.

21. Combination of an engine exhaust pipe, a turbocharger having an exhaust gas outlet communicated to the exhaust pipe, and the gasket of claim 9 between the engine exhaust pipe and the turbocharger.
